(19) United States
(12) Patent Application Publication
(10) Pub. No.: US 2007/0035943 A1
(43) Pub. Date: Feb. 15, 2007

(54) Shining utensil assembly for use in bar and kitchen

(76) Inventor: Chih-Hung Wang, Tainan Hsien (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/199,120

(22) Filed: Aug. 9, 2005

(51) Int. Cl. F21V 33/00

(52) U.S. Cl. 362/119; 219/109; 362/234

(57) ABSTRACT

An utensil assembly includes a base, and several utensils; the base has several fitting portions on an upper side thereof, an IC board therein, and several light emitting diodes, which are held in respective ones of the fitting portions, and connected to and controlled with the IC board; each of the utensils includes an end portion, which is pervious to light; the utensils are supported on respective ones of the fitting protrusions of the base at the end portions thereof such that when the light emitting diodes are powered to produce light, the light will travel through the pervious-to-light end portions of the utensils; therefore, the utensils will be clearly seen when the environment doesn't have enough illumination.

### BACKGROUND OF THE INVENTION

1. Field of the Invention

The present invention relates to a shining utensil assembly for use in bar and kitchen, more particularly one, which includes a base having light emitting diodes thereon, and several different utensils each having a pervious-to-light end portion and supported on the base.

2. Brief Description of the Prior Art

Utensils for use in bars and kitchens are usually made of metallic materials and plastic materials. The conventional utensils can be clearly seen when the room has enough illumination. However, the utensils can't be clearly seen when the room has little illumination. When the utensils are used in a bar or a pub, in which the illumination is usually decreased so as to create a special atmosphere, the bartenders can't clearly see the utensils, and they are prone to take a wrong one from the various utensils.

### SUMMARY OF THE INVENTION

It is a main object of the invention to provide a shining utensil assembly for use in bar and kitchen to overcome the above-mentioned problem. The shining utensil assembly of the invention includes a base, and several utensils. The base has several fitting portions on an upper side, an IC board, and several light emitting diodes, which are held in the fitting portions, and connected to the IC board. Each utensil includes a pervious-to-light end portion. The utensils are supported on respective ones of the fitting protrusions of the base at the end portions. Therefore, light emitted from the light emitting diodes will travel through the pervious-to-light end portions of the utensils to make the utensils clearly seen.

### BRIEF DESCRIPTION OF THE DRAWINGS

The present invention will be better understood by referring to the accompanying drawings, wherein:

FIG. 1 is an exploded perspective view of the first preferred embodiment of a shining utensil assembly of the invention,

FIG. 2 is an exploded perspective view of the second embodiment,

FIG. 3 is a vertical sectional view of the first embodiment,

FIG. 4 is a vertical sectional view of the second embodiment,

FIG. 5 is a vertical section of the first embodiment, showing the position of the circuit board, and

FIG. 6 is an exploded perspective view of the third embodiment.

### DETAILED DESCRIPTION OF THE PREFERRED EMBODIMENTS

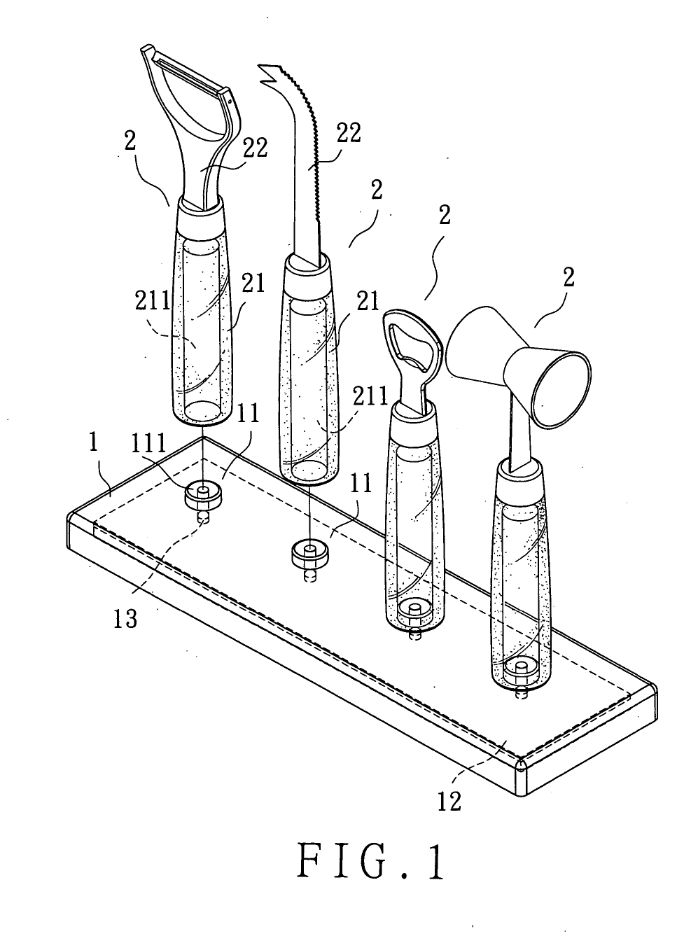

Referring to FIG. 1, a first preferred embodiment of a shining utensil assembly for use in bar and kitchen includes a base 1, and various utensils 2. The base 1 has several fitting portions 11 on an upper side thereof, an IC board 12 therein, and several light emitting diodes (LED) 13 electrically connected to and controlled with the IC board 12; the light emitting diodes (LED) 13 are in various colors; each of the fitting portions 11 of the base 1 is a protrusion 111. The light emitting diodes 13 are held in respective ones of the fitting portions 11, and visible from above the base 1. The kitchen utensils 2 are measuring cups, knives, bottle openers etc. Each of the utensils 2 includes an utensil end 22, and a pervious-to-light end portion 21, which has a handle tube 211, and which is securely joined to the utensil end 22.

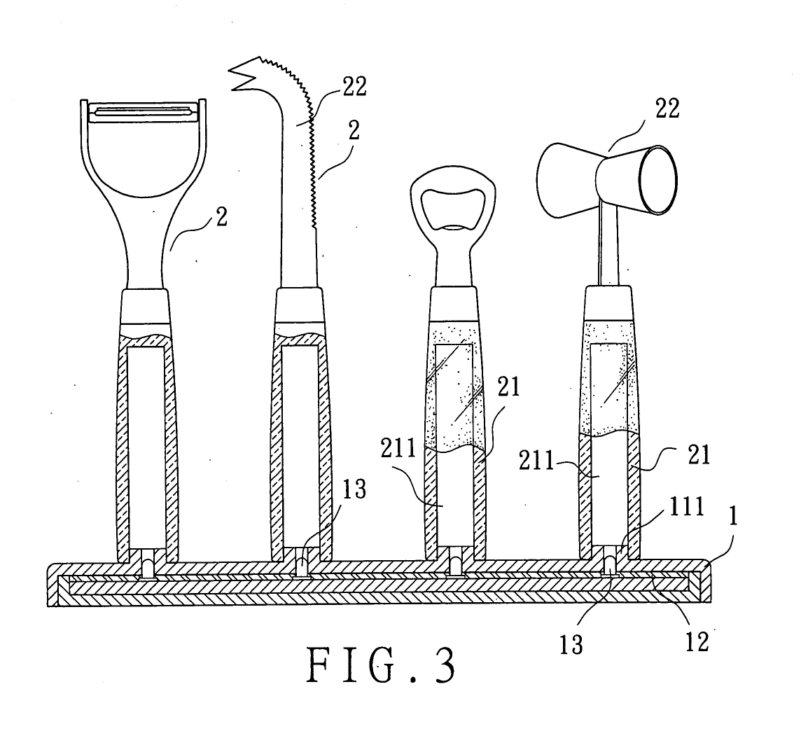

Referring to FIG. 3, the utensils 2 are fitted over respective ones of the protrusions 111 of the base 1 at the pervious-to-light end portions 21 thereof. Thus, the utensils 2 are held in vertical position. When the light emitting diodes 13 are powered, light from the light emitting diodes 13 will travel through the pervious-to-light end portions 21 of the utensils 2, and the whole utensil assembly will look attractive, and the utensils 2 clearly seen. Therefore, the users are allowed to see the utensils clearly, and they can't possibly take a wrong one from the utensil assembly even if it is dark. And, when the present utensil assembly is used in a bar or a pub, in which the illumination is usually decreased so as to create a special atmosphere, the bartenders can clearly see the utensils 2, and can't take a wrong one from the various utensils 2.

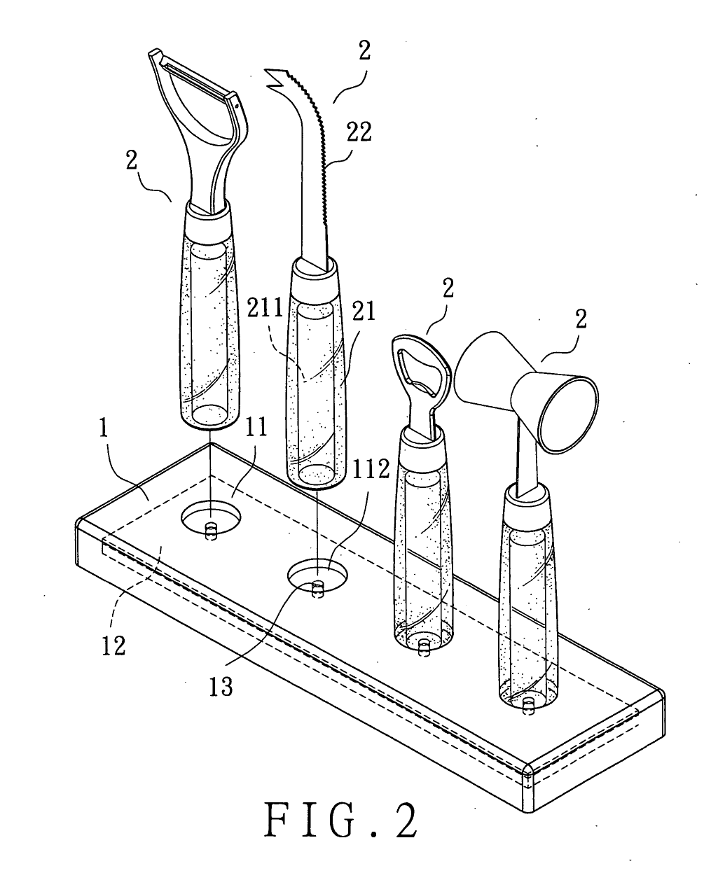

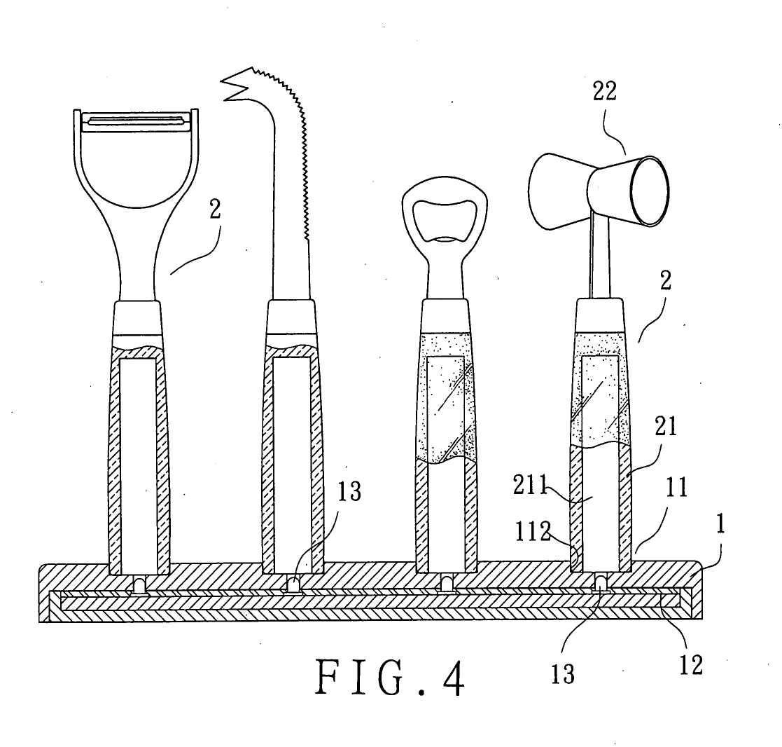

Referring to FIG. 2, in a second preferred embodiment of the invention, each fitting portion 11 is a recess 112 instead of a protrusion 111. And, the utensils 2 are fitted in respective ones of the recesses 112 at the pervious-to-light end portions 21 thereof, as shown in FIG. 4; thus, the utensils 2 are held in position.

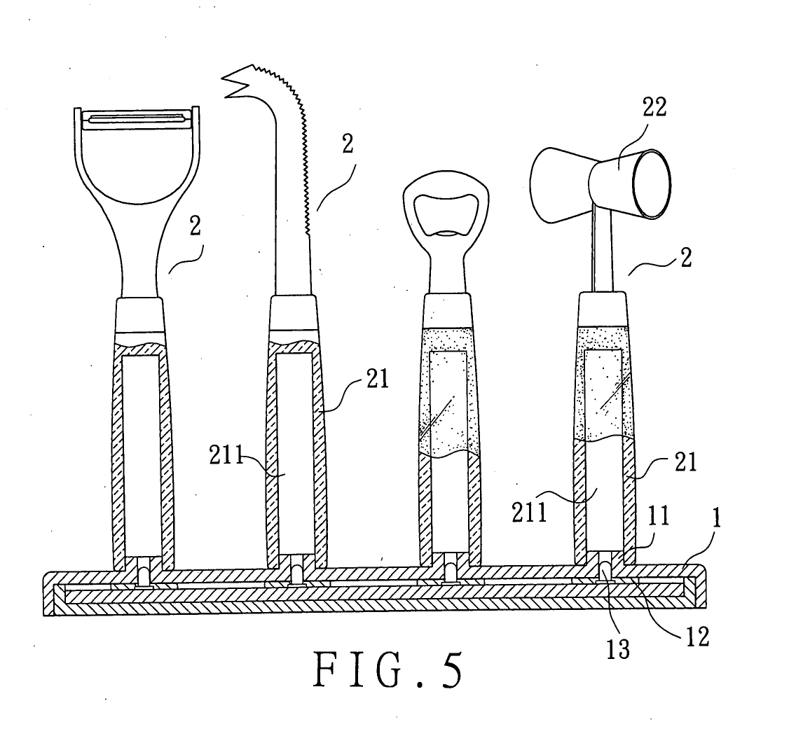

Furthermore, there can be several IC boards 12 instead, each electrically connected to one of the light emitting diodes 13, as shown in FIG. 5. Or alternatively, there can be several IC boards 12, each electrically connected to a few ones of the light emitting diodes 13, as shown in FIG. 3.

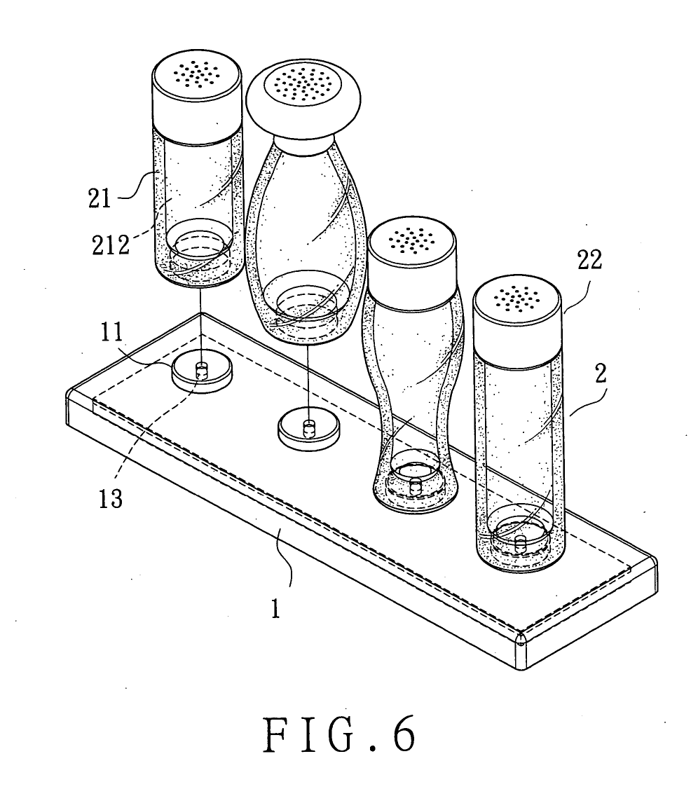

Referring to FIG. 6, in a third preferred embodiment of the present invention, each of the ends 22 of the utensils 2 has a cover, and each of the pervious-to-light end portions 21 of the utensils 2 has a holding room 212 for containing seasonings such as salt, sugar, and pepper, which pervious-to-light end portion 21 is joined to the cover; the cover at the end 22 has several holes thereon for allowing seasonings held in the holding room 212 to be dispensed through.

From the above description, it can be seen that the shining utensil assembly of the present invention has the following advantages:

1. Because light is emitted from the light emitting diodes on the base and travels through the utensils, the users are allowed to see the utensils clearly when the environment doesn't have enough illumination. Therefore, the users can't possibly take a wrong one from the utensil assembly even if the environment doesn't have enough illumination.

2. The utensil assembly will look attractive when it is placed on a bar, with the light emitting diodes producing light, and the light traveling through the utensils.

3. The utensils can be seasoning containers besides being measuring cups, knives, and bottle openers. Therefore, the utensil assembly can serve a wide variety of purposes.

What is claimed is:

1. A shining utensil assembly, comprising
a base; the base having a plurality of fitting portions on an upper side thereof; the base having an IC board therein; the base having a plurality of light emitting diodes connected to and controlled with the IC board; the light emitting diodes being held in respective ones of the fitting portions in such a way as to be visible from above the base; and
a plurality of utensils; each of the utensils including an utensil end, and a pervious-to-light end portion securely joined to the utensil end, which pervious-to-light end portion has a handle tube;
the utensils being supported on respective ones of the fitting protrusions of the base at the pervious-to-light end portions thereof such that when the light emitting diodes are powered to produce light, the light will travel through the pervious-to-light end portions of the utensils.

2. The shining utensil assembly as claimed in claim 1, wherein each of the fitting portions of the base is a protrusion, and the utensils are fitted over respective ones of the fitting portions of the base at the pervious-to-light end portions thereof.

3. The shining utensil assembly as claimed in claim 1, wherein each of the fitting portions of the base is a recess, and the utensils are fitted in respective ones of the fitting portions of the base at the pervious-to-light end portions thereof.

4. The shining utensil assembly as claimed in claim 1, wherein each of the pervious-to-light end portions of the utensils has a holding room for containing seasonings.

5. The shining utensil assembly as claimed in claim 1, wherein there are plural IC boards fitted in the base, and each electrically connected to one of the light emitting diodes.

6. The shining utensil assembly as claimed in claim 1, wherein there are plural IC boards fitted in the base, and each electrically connected to a few ones of the light emitting diodes.
